(19) United States
(12) Patent Application Publication
(10) Pub. No.: US 2024/0020667 A1
(43) Pub. Date: Jan. 18, 2024

(54) CHARGING MANAGEMENT ENGINE IN AN ELECTRIC VEHICLE MANAGEMENT SYSTEM

(71) Applicant: Rivian IP Holdings, LLC, Irvine, CA (US)

(72) Inventors: Chakravarthy K. ALLAMSETTY, San Jose (US); Connie Wong YANG, Saratoga, CA (US)

(21) Appl. No.: 17/866,186

(22) Filed: Jul. 15, 2022

(51) Int. Cl. G06Q 20/14; B60L 53/66; B60L 53/65

(52) U.S. Cl. CPC G06Q 20/145; B60L 53/665; B60L 53/65

(57) ABSTRACT

Methods, systems, and computer storage media for providing energy consumption tracking data based on tracking energy consumption of a charging station for a charging session of an electric vehicle (EV). The energy consumption tracking data can be used to calculate a reimbursement amount for electrical expenses for recharging the EV at a charging station (e.g., charging station at home). Operationally, eligibility data is received at the charging station, the eligibility data identifies an EV as eligible for energy consumption tracking at the charging station. Based on the eligibility data, a determination is made that the EV is eligible for energy consumption tracking to cause tracking energy consumption associated with charging the EV at the charging station. Based on tracking the energy consumption, energy consumption tracking data is generated for the EV at the charging station, and the energy consumption tracking data comprising a calculated energy consumption reimbursement amount is communicated.

### INTRODUCTION

Drivers rely on electrical power to power electric vehicles (EVs) and gas for gas-powered vehicles. Charging stations use electrical power to charge EVs and gas stations provide fuel that is used to power gas-powered vehicles. Charging stations for EVs are available anywhere with electrical power for the charging station—including at the homes of EV drivers.

### SUMMARY

Various aspects of the technology described herein are generally directed to systems, methods, and computer storage media for, among other things, providing energy consumption tracking data based on tracking energy consumption of a charging station for a charging session of an EV. The energy consumption tracking data can be used to calculate a reimbursement amount for electrical expenses for recharging the car at a charging station (e.g., charging station at home). For example, a company may provide electric vehicles to its employees—or maintain a fleet of vehicles used by employees—and reimburse employees for at-home charging based on automatically receiving energy consumption tracking data—via tracking energy consumption of a home charging station.

Operationally, a charging station is equipped with the capacity to provision and authenticate an EV and/or EV user to securely track and communicate how much energy (i.e., energy consumption tracking data) is used—to recharge the EV—during a charging session at the charging station. For example, an EV charging protocol can be implemented to execute a first set of operations for a first EV whose energy consumption is tracked and to execute a second set of operations for a second EV whose energy consumption is not tracked. The energy consumption tracking data is used to generate a calculated energy consumption reimbursement amount.

By way of context, companies can reimburse drivers for gas for their vehicles when the drivers submit receipts indicating a cost for the gas used. With electric vehicles (EVs), drivers may want to charge their EVs at home—or other private charging stations—and be reimbursed for the power consumed to charge the car. Typically, public charging stations provide an amount payable upon charging the car. The same is not true when charging the car at home (e.g., electrical fees for home charging stations—or wallboxes—are charged by the corresponding electric company). As such, a technical solution can be implemented to address technical limitations in EV charging management and reimbursement.

In one embodiment, a charging management engine generates eligibility data that identifies an EV as eligible for energy consumption tracking at a charging station, and then communicates the eligibility data to the charging station or the EV. Based on communicating the eligibility data to the charging station of the EV, the charging management engine receives energy consumption tracking data and communicates the energy consumption tracking data, where the energy consumption tracking data comprises a calculated energy consumption reimbursement amount.

In another embodiment, a charging station receives eligibility data that identifies an EV as eligible for energy consumption tracking at the charging station. Based on the eligibility data, the charging station determines that the EV is eligible for energy consumption tracking. The charging station tracks energy consumption associated with charging the EV at the charging station. Based on tracking the energy consumption, the charging station generates energy consumption tracking data for the EV at the charging station and communicates the energy consumption tracking data.

In another embodiment, an EV receives eligibility data that identifies the EV as eligible for energy consumption tracking at a charging station. The EV communicates the eligibility data to the charging station to cause generation of energy consumption tracking data for the EV at the charging station, and then receives the energy consumption tracking data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1C are block diagrams of exemplary schematics of a charging management system for providing energy consumption tracking data, in accordance with aspects of the technology described herein;

FIG. 2A a schematic diagram of an exemplary charging management system for providing energy consumption tracking data, in accordance with aspects of the technology described herein;

FIG. 2B is a schematic diagram of an exemplary charging management system for providing energy consumption tracking data, in accordance with aspects of the technology described herein;

FIG. 3 is a flow diagram of an exemplary method for providing energy consumption tracking data in a charging management system, in accordance with aspects of the technology described herein;

FIG. 4 is a flow diagram of an exemplary method for providing energy consumption tracking data in a charging management system, in accordance with aspects of the technology described herein;

FIG. 5 is a flow diagram of an exemplary method for providing energy consumption tracking data in a charging management system, in accordance with aspects of the technology described herein;

FIG. 6 provides a block diagram of an exemplary electric vehicle management system suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

An electric vehicle management system can support a network of resources and services to support electric vehicle management operations associated with navigation, autonomous driving, charging management, and so on. A charging station system (e.g., a charging station) of an electric vehicle management system can operate as part of the electric vehicle (EV) management system to provide powering, charging, tune-up, or other suitable charging management services and operations. In particular, the charging station system may deliver electrical power to an EV to power the EV for transportation and other functionality. Charging station systems for EVs can be available anywhere with electrical power for a charging station—including at the homes of EV drivers. While public charging stations provide an amount payable upon charging the car, the same is not true when charging the car at home (e.g., electrical fees for home charging stations are charged by the corresponding electric company).

Different types of reimbursors (e.g., a company, an employer, or a contractee) provide reimbursement to a reimbursee (e.g., a worker, an employee, or a contractor) for gas for a vehicle when the reimbursee submits a receipt indicating a cost for the gas used. However, electric vehicle management systems lack computing logic and infrastructure for a comprehensive technical solution for calculating a reimbursement amount for electrical power that is used to recharge an EV. In particular, home charging stations do not provide gas-station-type receipts to use for the reimbursements. Although some public charging stations might provide an amount payable upon charging the EV, the same is not true when charging the EV at a private location or at home (e.g., electrical fees for home charging stations are charged by a corresponding electric company); and the amount charged at a public charging station may not reflect exclusively a cost associated with the electrical fees for charging the EV.

Moreover, charging stations of electric vehicle management systems do not provide provisioning and EV charging management operations between a charging station and a charging management engine, an EV and the charging station, the EV and a user device, the user device and the charging station, or an EV charging management administrator device. For example, an electric vehicle management system may not be configured to determine whether a particular EV or a particular user of the EV is eligible for reimbursement at a charging station, nor configured to provision a charging station for energy consumption tracking and reimbursement, or associate a particular user with a particular EV— based on a communication with the charging station. Developing an improved reimbursement technical solution can be particularly challenging because of some of the existing infrastructure and limitations described above. As such, a more comprehensive electric vehicle management system—with an alternative basis for generating a calculated reimbursement amount for energy consumption used to charge an EV— can improve operations and interfaces associated with charging station systems.

Embodiments described herein are generally directed to systems, methods, and computer storage media for, among other things providing energy consumption tracking data based on tracking energy consumption of a charging station for a charging session of an EV. The energy consumption tracking data can be used to calculate a reimbursement amount for electrical expenses for recharging the car at a charging station (e.g., charging station at home). For example, a company may provide electric vehicles to its employees and reimburse employees for at-home charging based on automatically receiving energy consumption tracking data—via tracking energy consumption of a home charging station. For example, the reimbursement amount may be determined using a particular energy fee (i.e., utility data)—from a utility company—of a charging session when the energy consumption data was tracked.

By way of example, a reimbursor may provide electric vehicles to its reimbursees who are eligible for reimbursement from the reimbursor. Since receipts are not generated for individual payment at a private charging station (like at the gas station), the electric vehicle management system (or charging management system) provides for generating energy consumption tracking data when privately charging an eligible EV (e.g., at-home charging). In particular, based on the eligibility data, a determination is made that an EV is eligible for energy consumption tracking to cause tracking energy consumption associated with charging the EV at a charging station. Based on tracking the energy consumption, energy consumption tracking data is generated for the EV at the charging station, and the energy consumption tracking data comprising a calculated energy consumption reimbursement amount is communicated to one or more client devices.

Generating energy consumption tracking data and energy consumption reimbursement amounts can be based on a collection of EVs—or in some specific instances a fleet of EVs—for a company. As such, an electric vehicle charging management administrator device may have an interface capable of managing, comparing, analyzing, and viewing EVs and their corresponding energy consumption tracking data and energy consumption reimbursement amounts. The interface may be associated with a charging management engine that centrally manages provisioning operations, energy consumption tracking operations, and reimbursement calculation operations. Energy consumption reimbursement amounts, associated with the reimbursement calculation, may be calculated based in part on using a particular energy fee, from a utility company, that corresponds to the charging session at the charging station. The charging management engine can communicate energy consumption tracking data (including reimbursement amounts) via the charging station, EV, mobile device, or electric vehicle charging management administrator device.

Additionally, a charging station may be equipped with the capacity to provision and authenticate an EV and/or an EV user (e.g., via a mobile device application) to securely track and communicate how much power is used—to recharge the EV— during a charging session at the charging station. For example, an EV charging protocol can be implemented to execute a first set of operations for a first EV whose energy consumption is tracked and to execute a second set of operations for a second EV who energy consumption is not tracked. The EV charging protocol (e.g., SAE J1772) can be modified to include operations for using eligibility data to determine that an EV is eligible for energy consumption tracking for reimbursement and configuring charging session parameters for the charging station—based on eligibility data—to support energy consumption tracking and reimbursement.

Further, a mobile device application can be used to support provisioning operations and communications for setting up the EV and charging station for their corresponding functionality. For example, the mobile device application can be used for provision an EV with a charging station and determine that a user of a particular EV is eligible for reimbursement from a reimbursor for charging their EV at a charging station. The mobile device application can further be used to authenticate the user for a particular charging session at a charging station for energy consumption tracking for reimbursement.

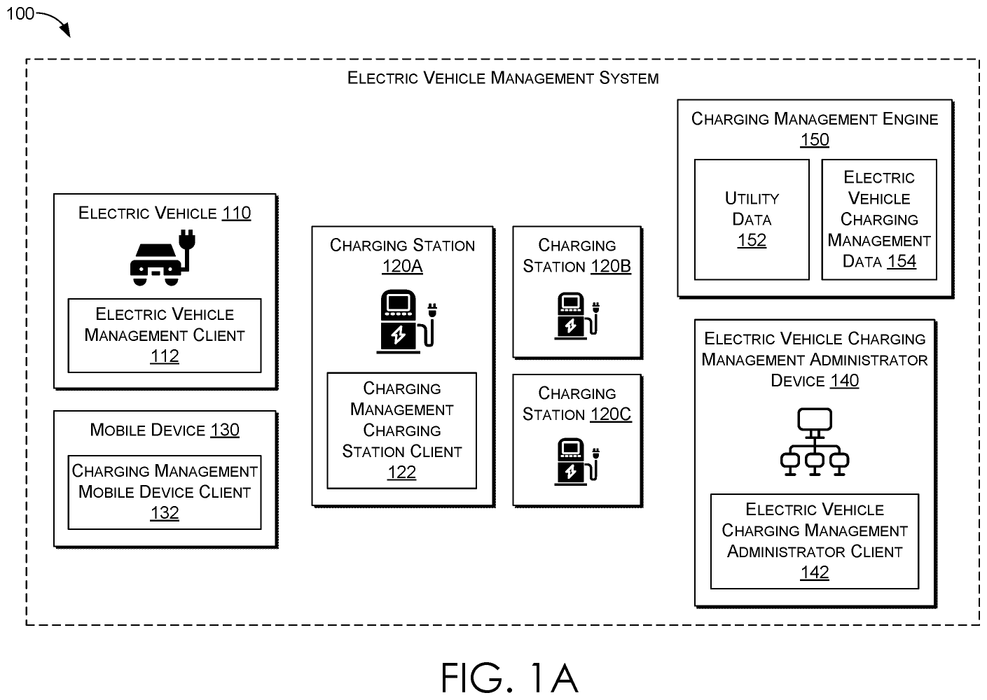

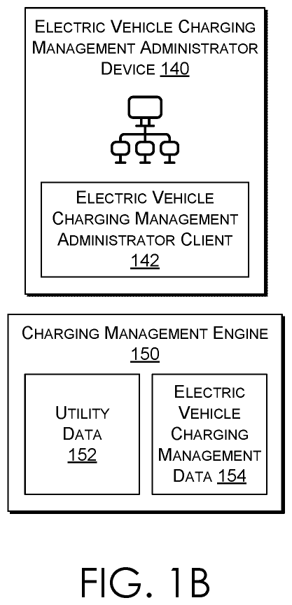

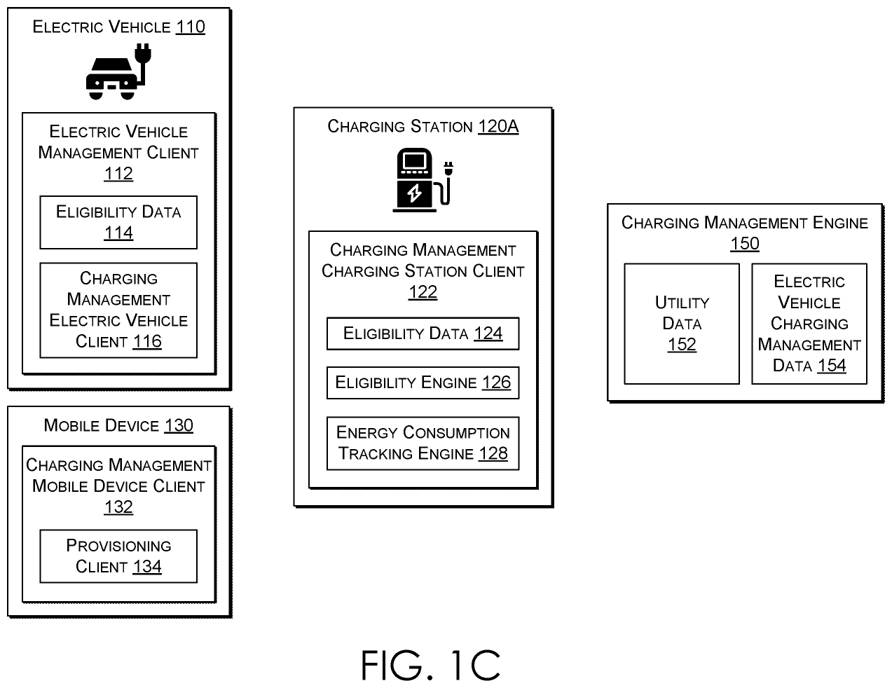

Aspects of the technical solution can be described by way of examples and with reference to FIGS. 1A-1C. FIG. 1A illustrates electric vehicle management system 100 (charging management system) having electric vehicle 110 with electric vehicle management client 112; charging station 120A with charging management charging station client 122; charging station 120B; charging station 120C; mobile device 130 with charging management mobile device client; electric vehicle charging management administrator device 140 with electric vehicle charging management administrator client 142; and charging management engine 150 with utility data 152 and electric vehicle charging management data 154.

Operationally, an electric vehicle management system 100 can provide electric vehicle management features (e.g., a cloud-based network of applications, services, and hardware and software resources) that support different aspects (e.g., infotainment, autonomous driving, and charging system management) of an electric vehicle management system. A driver may drive an electric vehicle 110 that includes electric vehicle management client 112 that provides client-side access to the electric vehicle management features. Other devices can include clients that support client-side access to electric vehicle management features (e.g., mobile device 130 with charging management mobile device client 132; charging station 120A with charging management charging station client 122; and electric vehicle charging management administrator device 140 with electric vehicle charging management administrator client 142).

Charging station 120A (e.g., electric vehicle supply equipment “EVSE”) and electric vehicle 110 can communicate via an EV charging protocol that defines the type of connector for an inlet of the electric vehicle 110, max power and voltage for the connection, type of communication link, and communication protocols. Charging station 120A connects the electric vehicle 110 to an electrical supply and further supports provisioning and other charging station operations (e.g., authentication, metering, and remote monitoring).

The charging management engine 150 can operate as a central management system (e.g., a cloud-based backend system) such that the charging station 120A communicates with the charging management engine 150 for charging station operations. The charging management engine 150 also supports provisioning operations—via mobile 130—to associate the electric vehicle 110 with a user (e.g., driver) to manage charging the electric vehicle 110 at charging station 120A. The charging management engine 120 supports a charging management mobile device client 132 (and other user-facing applications) to help with charging management operations (e.g., finding nearest charging station and reserving a charging station and payment).

With reference to FIG. 1B, FIG. 1B illustrates electric vehicle charging management administrator device 140 with electric vehicle charging management administrator client 142, and charging management engine 150 with utility data 152 and electric vehicle charging management data 154. The electric vehicle management system 110 can provide a variety of EV management features—including infrastructure and software—that manage charging functionality associated with EVs, charging stations, mobile devices, electric vehicle charging management administrator devices, and charging management devices. The electric vehicle management system 100 can operate based on integration with cloud technology to communicate messages between devices to support functionality described herein. For example, the charging management engine 150 can communicate with electric vehicle charging management administrator device 140 to determine EVs that are to be tracked for energy consumption reimbursement. Based on receiving, from the electric vehicle charging management administrator device 140, an indication of EVs that should be tracked, the charging management engine 150 can generate eligibility data.

By way of illustration, the charging management engine 150 generates eligibility data that supports energy consumption tracking for reimbursement. The eligibility data can refer to configuration data associated with specific attributes (e.g., EV attributes, user attributes, EV charging protocol operations attributes) that support energy consumption tracking at a charging station for a particular electric vehicle. The eligibility data can be generated based on a request and information (e.g., electric vehicle charging management data 154) from an electric vehicle charging management administrator device 140 device to enable an EV for energy consumption tracking and reimbursement. As discussed in more detail below, upon receiving the energy consumption tracking data—based on communicating the eligibility data—the charging management engine 150 can communicate energy consumption tracking data comprising a calculated energy consumption reimbursement amount to the electric vehicle charging management administrator device 140

With reference to FIG. 1C, FIG. 1C illustrates electric vehicle 110 with electric vehicle management client 112 including eligibility data 114 and charging management electric vehicle client 116; mobile device 130 with charging management mobile device client 132 including provisioning client 134; and charging station 120A with charging management charging management charging station client including eligibility data 124, eligibility engine 126 and energy consumption tracking engine 128.

Charging management engine 150 communicates eligibility data to the charging station 120A or electric vehicle 110. The charging station 120 implements a charging management charging station client 122 that is configured to receive and process eligibility data. The electric vehicle 110 implements an electric vehicle management client 112 that includes the eligibility data 114 and a charging management electric vehicle client 116 that supports performing charging management operations at the electric vehicle 110. The mobile device 130 implements the charging management mobile device client 132 and provisioning client 134 to provision the electric vehicle 110 for charging at the charging station 120. The provisioning operations can include authentication of the EV and user based on eligibility data, unique EV identifiers, or unique user identifiers. It is contemplated that the charging station can include a provisioning client that supports provisioning the charging station directly with charging management engine 150.

Charging station 120A includes the charging management station client 122 that implements an eligibility engine 124 that processes the eligibility data 124 (and/or eligibility data 114) to enable energy consumption tracking for reimbursement. The charging station can be provisioned directly with the charging management engine 150 to support energy consumption tracking for an EV. The eligibility data 124 (or eligibility data 114) can trigger a set of energy consumption tracking operations via the energy consumption tracking engine 124. The charging station 120A can communicate to the charging management engine 150. The charging management engine 150 uses utility data 152 to calculate energy consumption reimbursement.

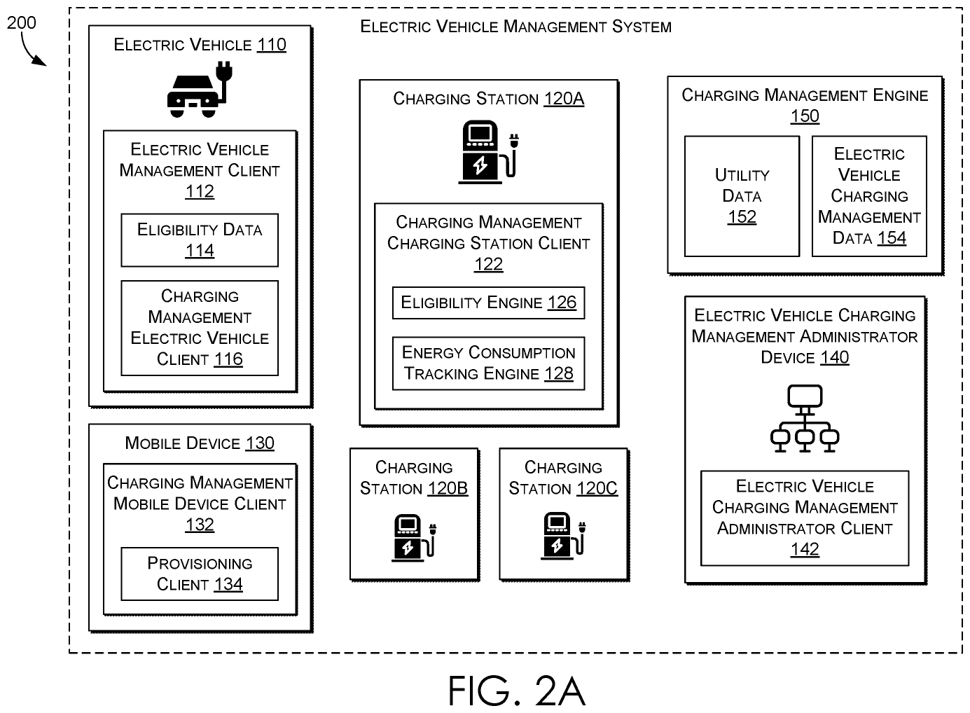

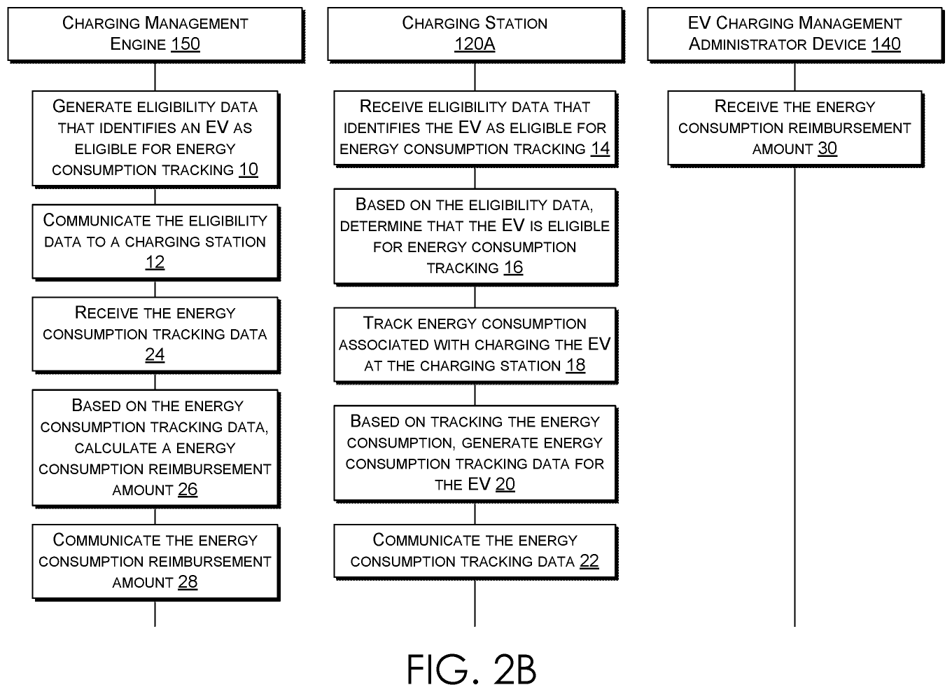

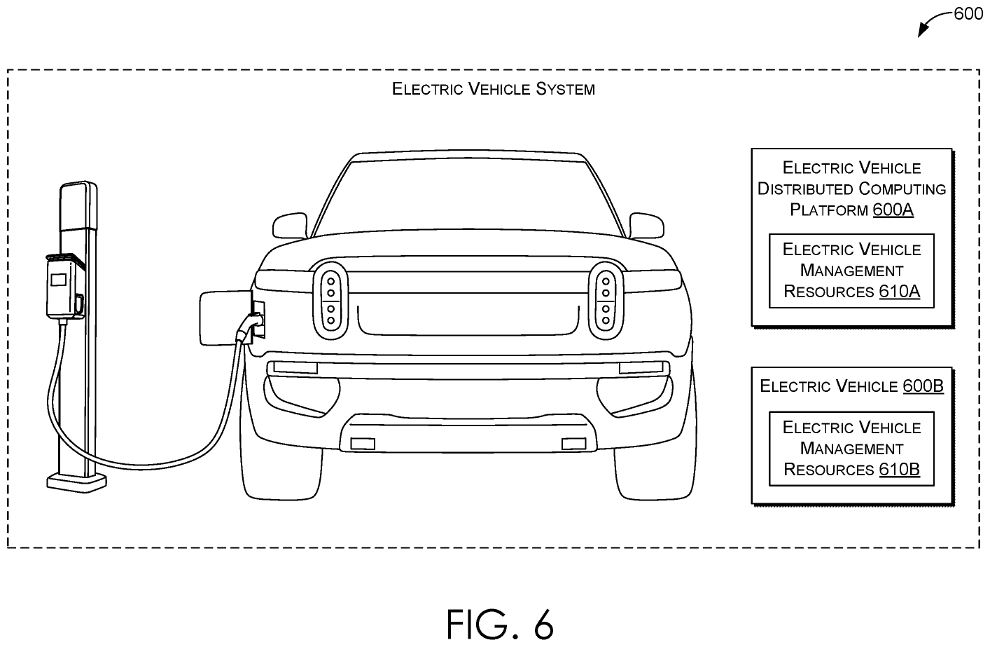

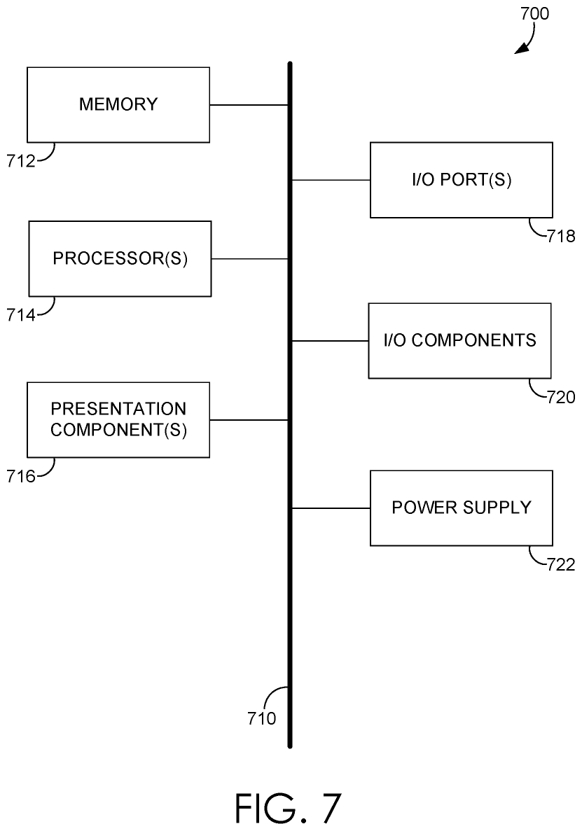

Aspects of the technical solution can be described by way of examples and with reference to FIGS. 2A and 2B. FIG. 2A is a block diagram of an exemplary technical solution environment, based on example environments described with reference to FIGS. 6, 7 and 7 for use in implementing embodiments of the technical solution are shown. Generally the technical solution environment includes a technical solution system suitable for providing the example electric vehicle management system 100 in which methods of the present disclosure may be employed. In particular, FIG. 2A shows a high level architecture of the electric vehicle management system 100 in accordance with implementations of the present disclosure. Among other engines, managers, generators, selectors, or components not shown (collectively referred to herein as “components”), the technical solution environment of electric vehicle management system 100 corresponds to FIGS. 1A and 1B.

With reference to FIG. 2A, FIG. 2A illustrates electric vehicle 110 with electric vehicle management client 112 including eligibility data 114 and charging management electric vehicle client 116; mobile device 130 with charging management mobile device client 132 including provisioning client 134; and charging station 120A with charging management charging management charging station client including eligibility engine 122 and energy consumption tracking engine 124.

The electric vehicle management system 100 supports providing energy consumption tracking for generating an energy consumption reimbursement amount. Charging management engine 150 generates eligibility data that identifies an electric vehicle (EV) (e.g., electric vehicle 110) as eligible for energy consumption tracking a charging station (e.g., charging station 120A). The eligibility data can be associated with an EV charging protocol. Based on the eligibility data the EV charging protocol triggers a first set of operations for energy consumption tracking, and without the eligibility data the EV charging protocol triggers a second set of operations for energy consumption tracking. The charging protocol set of operations can support receiving and processing different types of eligibility data from different sources and combination the eligibility data to make a determination that an EV is eligible for energy consumption tracking for reimbursement. Charging management engine 150 communicates the eligibility data to the electric vehicle 110 that causes generation of energy consumption tracking data at a charging station.

The charging management engine 150 can receive energy consumption tracking data. The energy consumption tracking data be associated with a plurality of EVs, each of the plurality of EVs having their corresponding eligibility data. In particular, eligibility data of a first EV of the plurality EVs is associated with a first user and eligibility data of a second EV of the plurality of EVs is associated with a second user. The energy consumption tracking data can be received from the EVs, charging stations, or mobile devices. The charging management engine 150 can compare consumption tracking energy consumption tracking data of a first EV and energy consumption tracking data of a second EV to generate comparison results data. The charging management engine 150 can further cause display of the comparison results data on a graphical user interface of a client device.

The charging management engine 150 calculates an energy consumption reimbursement amount. The energy consumption reimbursement amount can be determined using utility data. Utility data can be associated with a particular geographic area associated with the charging station. The calculated energy consumption reimbursement amount correspond to a charging session of the EV at the charging station, where the charging session is associated with a start time and a stop time.

The charging station 120A receives eligibility data that identifies an EV as eligible for energy consumption tracking at the charging station. The eligibility data can be received from the charging management engine 150 or received from the EV (e.g., via a short-range, low-energy signal). Based on the eligibility data, the charging station 120A determines that the EV is eligible for energy consumption tracking. Determining that the EV is eligible for energy consumption tracking is further based on receiving, at the charging station, a unique user identifier associated with the eligibility data, where the unique user identifier identifies a user as eligible for energy consumption tracking at the charging station.

The charging station 120A tracks the energy consumption associated with charging the EV at the charging station. The charging station 120A tracks the energy consumption based on an initiated charging session of the EV at the charging station. Based on tracking the energy consumption, the charging station generates energy consumption tracking data for the EV at the charging station. It is contemplated that the charging station 120A can receive utility data for a particular geographic area associated with the charging station and calculate the energy consumption reimbursement amount using the utility data and the energy consumption tracking data for the EV during particular charging sessions. The charging station 120A communicates the energy consumption tracking data. The charging station 120A can also communicate an energy consumption reimbursement amount to a user device of a user of the EV.

By way of example, the electric vehicle 110 can receive eligibility data that identifies the electric vehicle 110 as eligible for energy consumption tracking at a charging station. The electric vehicle 110 communicates the eligibility data to the charging station to cause generation of energy consumption tracking data for the EV at the charging station. Based on communicating the eligibility data, the electric vehicle 110 receives the energy consumption tracking data. The electric vehicle 110 further communicates a unique user identifier associated with the eligibility data to the charging station 120A to cause generation of the energy consumption tracking data. The unique user identifier indicates that the user is eligible for energy consumption tracking at the charging station.

The charging management engine 150 and the electric vehicle 110 can communicate the eligibility data comprising security information (e.g., certificate, keys, SSL) and the security information is associated with security operations that support causing the charging station 120A to cause generation of energy consumption tracking data. The charging management engine 150 or the electric vehicle 110 receives an energy consumption reimbursement amount calculated from the energy consumption tracking data and utility data for a particular area associated with the charging station and associated with a first charging session of the EV at the charging station. It is contemplated that the energy consumption tracking data is received in response to providing, to the charging station, one or more unique EV identifiers indicative of one or more corresponding EVs as eligible for an energy consumption reimbursement, the one or more unique EV identifiers are provided from the charging management engine or the user devices of the user of the one or more corresponding EVs.

With reference to FIG. 2B, FIG. 2B illustrates a electric vehicle management system charging management engine 150, electric vehicle 110, charging station 120A, electric vehicle charging management administrator device 140 for performing corresponding operations below for providing energy consumption tracking in the electric vehicle management system.

The charging management engine 150, at block 10, generates eligibility data that identifies an electric vehicle (EV) as eligible for energy consumption tracking, and at block 12, communicates the eligibility data to the charging station. The charging station 120A, at block 14, receives the eligibility data that identifies the EV as eligible for energy consumption tracking at the charging station, and at block 16, based on the eligibility data, determines that the EV is eligible for energy consumption tracking. The charging station, at block 18, tracks energy consumption associated with charging the EV at the charging station. At block 20, based on tracking the energy consumption, the charging station generates energy consumption tracking data for the EV, and at block 22, communicates the energy consumption tracking data.

At block 24, the charging management engine 150 receives the energy consumption tracking data, and at block 26, based on the energy consumption tracking data, calculates an energy consumption reimbursement amount. At block 28, the charging management engine 150, communicates the energy consumption reimbursement amount to an electric vehicle charging management device 140, and at block 36, the electric vehicle charging management device 140 receives the energy consumption reimbursement amount.

### Exemplary Methods

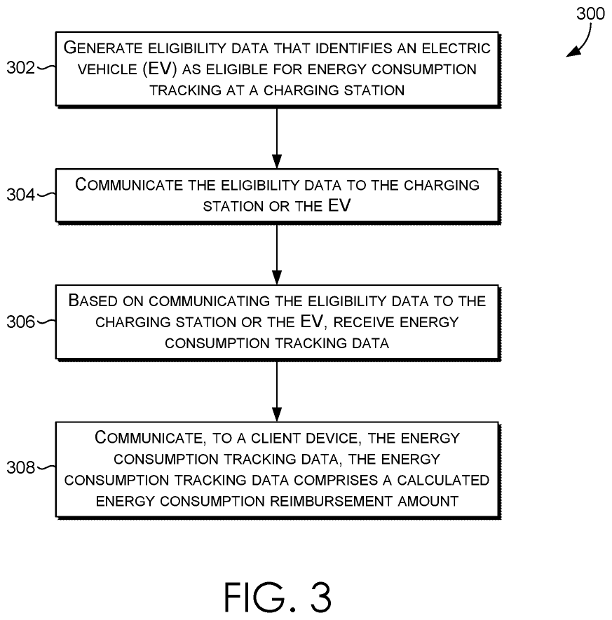

With reference to FIGS. 3, 4 and 5, flow diagrams are provided illustrating methods for providing energy consumption tracking in a charging management system. The methods may be performed using the electric vehicle management system described herein. In embodiments, one or more computer-storage media having computer-executable or computer-useable instructions embodied thereon that, when executed, by one or more processors can cause the one or more processors to perform the methods (e.g., computer-implemented method) in the electric vehicle management system (e.g., a computerized system or computing system).

Turning to FIG. 3, a flow diagram is provided that illustrates a method 300 for providing energy consumption tracking in a charging management system. Initially, at block 302, generate eligibility data that identifies an electric vehicle (EV) as eligible for energy consumption tracking at a charging station. At block 304, communicate the eligibility data to the charging station or the EV. At block 306, based on communicating the eligibility data to the charging station or the EV, receive energy consumption tracking data. At block 308, communicate, to a client device, the energy consumption tracking data. The energy consumption tracking data comprises a calculated energy consumption reimbursement amount.

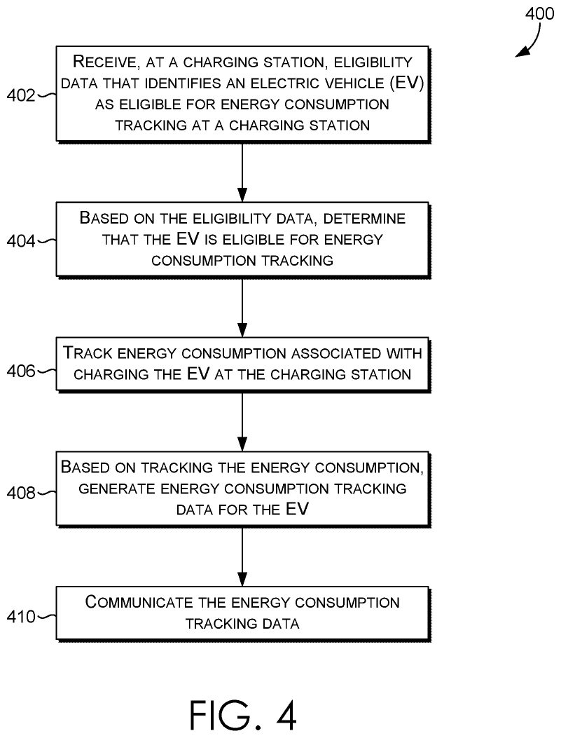

Turning to FIG. 4, a flow diagram is provided that illustrates a method 400 for providing energy consumption tracking in a charging management system. Initially, at block 402, receive, at a charging station, eligibility data that identifies an electric vehicle (EV) as eligible for energy consumption tracking at a charging station. At block 404, based on the eligibility data, determine that the EV is eligible for energy consumption tracking. At block 406, track energy consumption associated with charging the EV at the charging station. At block 408, based on tracking the energy consumption, generate energy consumption tracking data for the EV. At block 410, communicate the energy consumption tracking data.

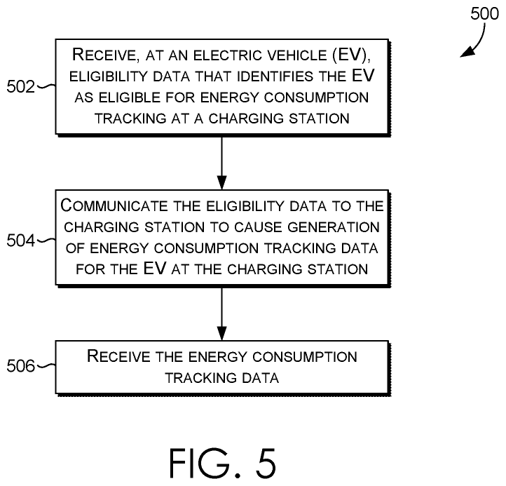

Turning to FIG. 5, a flow diagram is provided that illustrates a method 500 for providing energy consumption tracking in a charging management system. Initially, at block 502, receive, at an electric vehicle (EV), eligibility data that identifies the EV as eligible for energy consumption tracking at a charging station. Communicate the eligibility data to the charging station to cause generation of energy consumption tracking data for the EV at the charging station. At block 506, receive the energy consumption tracking data.

### Example Electric Vehicle System

With reference to FIG. 6, FIG. 6 illustrates an example electric vehicle system 600 in which implementations of the present disclosure may be employed. In particular, FIG. 6 shows a high level architecture of an example electric vehicle distributed computing platform 600A and electric vehicle 600B having electric vehicle management resources 610A and electric vehicle management resources 610B, respectively, that support the functionality described herein. The electric vehicle system 600 can host a technical solution environment, or a portion thereof.

The electric vehicle distributed computing platform 600A includes electric vehicle management resources 610A that provide and support electric vehicle distributed computing systems and operations. Electric vehicle distributed computing platform 600A can run cloud services across different data centers and geographic regions. Typically the electric vehicle distributed computing platform 600A acts to store data or run service applications in a distributed manner. For example, a service application can be supported a computing environment (e.g., host, node, and virtual machine) and resources (e.g., hardware resources and software resources) that are configured the service application; and a client device may be linked to a service application and configured to issue commands to the service application. Communications in the electric vehicle distributed computing platform 600A are performed through a virtual Internet Protocol (IP) and over a network (not shown), which may include, without limitation, one or more local area networks (LANs) and/or wide area networks (WANs).

The electric vehicle 600B includes electric vehicle management resources 610B that provide and support electric vehicle systems and operations. Electric vehicle 600B can refer to a vehicle that uses electric power. The electric vehicle 600B can be built on a configuration for an automotive chassis used for automotive platforms of battery electric vehicles. The configuration can include a base structure that houses the batteries, electric motors, and other electronic components of the electric vehicle. By way of example, the electric vehicle can include a steering system, brake sensor system, and controller systems.

Controllers can include one or more systems on chips (SoCs) that may provide signals to one or more components and systems of the vehicle. For example, controllers can support a steering system, braking system, one or more onboard computing devices, artificial intelligence functionality (e.g., computer vision), infotainment functionality, global navigation satellite systems and sensors (e.g., Global Positioning System sensors, RADAR sensors, LIDAR sensors) and inertial measurement unit (IMU) sensors (e.g., accelerometers, gyroscopes). Controllers may receive inputs (e.g., represented by input data) from and provide outputs (e.g., represented by output data, display data, etc.) via a human-machine interface (HMI) display @134 and other components of the electric vehicle.

The electric vehicle further includes a network interface which may use one or more wireless antenna(s) and/or modem(s) to communicate over one or more networks. For example, the network interface may be capable of communication over LTE, WCDMA, UMTS, GSM, CDMA2000, etc. The wireless antenna(s) may also enable communication between objects in the environment (e.g., vehicles, mobile devices, etc.), using local area network(s), such as Bluetooth, Bluetooth LE, Z-Wave, ZigBee, etc., and/or low power wide-area network(s) (LPWANs), such as LoRaWAN, SigFox, etc.

It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown. The various blocks are shown with lines for the sake of conceptual clarity, and other arrangements of the described components and/or component functionality are also contemplated. FIG. 6 is merely meant to illustrative of an example electric vehicle and electric vehicle system that can be used in connection with one or more embodiments of the present invention.

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
generating, at a charging management engine, eligibility data that identifies an electric vehicle (EV) as eligible for energy consumption tracking at a charging station;
communicating the eligibility data to the EV or the charging station;
based on communicating the eligibility data to the EV or the charging station, receiving energy consumption tracking data; and
communicating, to a client device, the energy consumption tracking data, wherein the energy consumption tracking data comprises a calculated energy consumption reimbursement amount.

2. The computerized system of claim 1, wherein the charging station communicates with the EV via a short-range, low-energy signal and communicates with an application installed on a user device, the application being associated with the EV and a user of the EV.

3. The computerized system of claim 1, the operations further comprising:
receiving the energy consumption tracking data for a plurality of EVs that each have corresponding eligibility data for identifying eligibility for energy consumption tracking at the charging station, wherein the energy consumption tracking data for the plurality of EVs is received in response to the charging station receiving the corresponding eligibility data;
comparing, via the charging management engine, energy consumption tracking data of a first EV and energy consumption tracking data of a second EV to generate comparison results data; and
based on comparing the energy consumption tracking data of the first EV and the second EV, causing display of the comparison results data on a graphical user interface of the client device.

4. The computerized system of claim 3, wherein eligibility data of the first EV of the plurality of EVs is associated with a first user and eligibility data of a second EV of the plurality of EVs is associated with a second user.

5. The computerized system of claim 1, wherein the calculated energy consumption reimbursement amount is determined using utility data for a particular geographic area associated with the charging station.

6. The computerized system of claim 5, wherein the calculated energy consumption reimbursement amount corresponds to a charging session of the EV at the charging station, the charging session having a start time and a stop time.

7. The computerized system of claim 6, wherein the eligibility data is associated with an EV charging protocol, wherein based on the eligibility data the EV charging protocol triggers a first set of operations for energy consumption tracking, and wherein without the eligibility data the EV charging protocol triggers a second set of operations associated with the energy consumption tracking.

8. One or more computer-storage media having computer-executable instructions embodied thereon that, when executed by a computing system having a processor and memory, cause the processor to perform operations comprising:
receiving, at a charging station, eligibility data that identifies an electric vehicle (EV) as eligible for energy consumption tracking at the charging station;
based on the eligibility data, determining that the EV is eligible for energy consumption tracking;
tracking energy consumption associated with charging the EV at the charging station;
based on tracking the energy consumption, generating energy consumption tracking data for the EV at the charging station; and
communicating the energy consumption tracking data.

9. The one or more computer storage media of claim 8, wherein the eligibility data is received from a charging management engine that generates the eligibility data.

10. The one or more computer storage media of claim 8, wherein determining that the EV is eligible for energy consumption tracking is further based on receiving, at the charging station, a unique user identifier associated with the eligibility data, the unique user identifier received from the EV or a user device of a user of the EV, the unique user identifier identifies a user as eligible for energy consumption tracking at the charging station.

11. The one or more computer storage media of claim 8, the operations further comprising receiving, at the charging station, utility data for a particular geographic area associated with the charging station and calculating the energy consumption reimbursement amount using the utility data and the energy consumption tracking data for the EV during a first charging session of the EV at the charging station.

12. The one or more computer storage media of claim 11, wherein the energy consumption reimbursement amount is communicated to a user device of a user of the EV.

13. The one or more computer storage media of claim 11, the operations further comprising:
tracking the energy consumption associated with charging the EV at the charging station during a second charging session;
receiving updated utility data for the particular geographic area associated with the charging station and the second charging session;
generating energy consumption tracking data for the second charging session;
calculating a second energy consumption reimbursement amount using the updated utility data and the energy consumption tracking data for the second charging session; and
comparing the first energy consumption reimbursement amount to the second energy consumption reimbursement amount.

14. The one or more computer storage media of claim 13, the operations further comprising communicating, to a user device of a user of the EV, the comparison of the first energy consumption reimbursement amount to the second energy consumption reimbursement amount.

15. A computer-implemented method, the method comprising:
receiving, at an electric vehicle (EV), eligibility data that identifies the EV as eligible for energy consumption tracking at a charging station;
communicating the eligibility data to the charging station to cause generation of energy consumption tracking data for the EV at the charging station; and
based on communicating the eligibility data, receiving the energy consumption tracking data.

16. The computer-implemented method of claim 15, further comprising communicating a unique user identifier associated with the eligibility data to the charging station to cause generation of the energy consumption tracking data, the unique user identifier indicates a user as eligible for energy consumption tracking at the charging station.

17. The computer-implemented method of claim 15, wherein the energy consumption tracking data is received in response to initiating a charging session at the charging station, the charging session being initiated upon receiving electrical power from the charging station.

18. The computer-implemented method of claim 15, further comprising receiving a energy consumption reimbursement amount calculated from the energy consumption tracking data and utility data for a particular geographic area associated with the charging station and associated with a first charging session of the EV at the charging station.

19. The computer-implemented method of claim 15, further comprising storing a certificate from the eligibility data at a local data store of the EV and communicating the certificate to the charging station to cause generation of the energy consumption tracking data.

20. The computer-implemented method of claim 15, wherein the energy consumption tracking data is received in response to providing, to the charging station, one or more unique EV identifiers indicative of one or more corresponding EVs as eligible for an energy consumption reimbursement, the one or more unique EV identifiers provided from user devices of the users of the one or more corresponding EVs.
